(19) United States
(12) Patent Application Publication
(10) Pub. No.: US 2007/0187339 A1
(43) Pub. Date: Aug. 16, 2007

(54) Drain receptacle for a fluid filter system

(76) Inventors: Keith R. Weinberger, Randolph, NJ (US); Mario A. Turchi, Tenafly, NJ (US); Sherwood Forlee, Elmhurst, NY (US)

Correspondence Address: MCANDREWS HELD & MALLOY, LTD, 500 WEST MADISON STREET, SUITE 3400, CHICAGO, IL, 60661, US

(21) Appl. No.: 11/352,772

(22) Filed: Feb. 13, 2006

(51) Int. Cl. B01D 35/14

(52) U.S. Cl. 210/767; 210/248

(57) ABSTRACT

A drain receptacle configured to drain fluid from a filtering device having first and second fluid passages, includes a base that may be integrally formed with upstanding walls, wherein a retention cavity is defined between the base and the upstanding walls, and a draining member extending from the base within the retention cavity. The draining member is configured to unseal or otherwise open at least one of the first and second fluid passages when the filtering device is secured to the drain receptacle in order to drain fluid within the filtering device into the retention cavity.

### BACKGROUND OF THE INVENTION

Embodiments of the present invention generally relate to a fluid filter assembly, such as an oil filter assembly, and more particularly to a drain receptacle that is configured to drain fluid trapped within a filtering device, such as a spin-on automotive oil filter or a module that has been removed from an adapter or base.

A conventional oil filter assembly for an internal combustion engine typically includes a threaded end, which is rotated, twisted, or spun, onto a corresponding mounting structure of the engine. Once the assembly is mounted onto the engine, oil is circulated through the engine for filtering. Unfiltered oil from the engine is passed through a filtering medium, such as a pleated paper cylinder, of the assembly. As the unfiltered oil passes through the filtering medium, impurities contained within the oil are retained by the filter medium. Filtered oil is then passed back into the engine. Eventually, an oil filter assembly, or at least the filtering medium within the assembly, needs to be replaced due to the fact that it becomes clogged with numerous impurities, thereby diminishing its filtering ability.

Typical filters may be one-, two-, or three-part filters, depending on whether the parts of the filter can be disconnected from one another. In a one-part filter assembly, the filter medium is contained within a housing, and the entire filter assembly is screwed onto and off of an engine. When the filter medium is clogged, the entire filter assembly must be replaced.

A typical two-part filter assembly includes a casing and a base that threadably engage one another to form a housing around the filter medium. The base is affixed to a mounting structure of an engine. For example, the base may be screwed onto a mounting stud of the engine. The casing, including the filter medium, may be removably secured, such as through threadable engagement, to the base, without removing the base from the engine. When the filter medium needs to be replaced, the casing is removed from the base, and a new casing is secured to the base.

A typical three-part filter assembly is similar to the two part filter assembly, except that the filter medium is separable from the rest of the assembly. As such, only the filter medium needs to be replaced, and the rest of the assembly may be reused with a new filter medium.

In order to change the filter medium in typical filters, one component is typically unscrewed from another component. The threads of, and/or other components (such as gaskets) located proximate to such threadable interfaces, are prone to sticking, which can pose difficulties in removing an oil filter from the engine (for a one-part filter assembly), or the casing from the base (for a two- or three-part filter assembly). Often, a specialized tool, such as an oil filter wrench, is required to remove the filter or casing from the engine. In many vehicles, however, the oil filter assembly is located at a position that is difficult to access. Thus, using a tool with some oil filters may be difficult.

Some filter assemblies include a filter module that is removably secured to a base or adapter. The adapter is secured to a mounting stud of a fluid source, such as an engine. When the filter is changed, the filter module is removed from the adapter, and a new filter module is secured to the adapter.

The filter module, which may be a spin-on one-piece filter or a portion of a separable filter assembly, may include at least one valve or sealing member that ensures that fluid within the filter module does not leak from the filter module after it is removed. As such, fluid may be trapped within the filter module after it is removed from the base or adapter. Further, fluid may be trapped in various types of filter devices when removed from a mounting stud.

Thus, a need exists for a system and method of removing fluid trapped within a filter module or other such device after it is removed from a mounting stud of a fluid source, such as an engine. In particular, a need exists for a system and method of draining oil from a filter module or housing after it has been disconnected from an adapter, base or mounting stud.

### SUMMARY OF THE INVENTION

Certain embodiments of the present invention provide a drain receptacle configured to drain fluid from a filtering device, such as a filter module, having first and second fluid passages, such as a fluid inlet and a fluid outlet. The drain receptacle includes a base integrally formed with upstanding walls and a draining member that extends from the base within a retention cavity that is defined between the base and the upstanding walls. The draining member may be configured to unseal or otherwise open at least one of the first and second fluid passages when the filtering device is secured to the drain receptacle in order to drain fluid within the filtering device into the retention cavity. The upstanding walls may form a spout configured to allow fluid collected within the retention cavity to be poured out of the retention cavity.

The draining member may include a post extending from a center of the base within the retention cavity. The post is configured to open the first fluid passage when the filtering device is secured to the drain receptacle. The draining member may also include at least one finger extending from the base within the retention cavity. The finger may be positioned a radial distance from the center of the base. The finger is configured to open the second fluid passage when the filtering device is secured to the drain receptacle.

A detent, such as, for example, a tab, may extend from at least one of the upstanding walls or the draining member within the retention cavity. A notch of the filtering device is configured to securely retain the detent to secure the filtering device to the drain receptacle. Optionally, the upstanding walls or the draining member include the notch or notches that are configured to securely retain the detent of the filtering device.

The base may include at least one drain passage and may be integrally connected to a bottle or various other types of oil storage receptacles. The drain passage is configured to allow fluid within the retention cavity to drain into the bottle through the drain passage.

Certain embodiments of the present invention also provide a method of draining fluid within a filtering device having fluid passages that are sealed. The method may include securing the filtering device to a drain receptacle, unsealing the fluid passages through the securing step, draining fluid within the filtering device through the unsealed fluid passages, collecting fluid from the draining step within a retention cavity of the drain receptacle, and pouring the fluid within the retention cavity into a disposal tank, or passing the fluid within the retention cavity into an integrally connected bottle.

### BRIEF DESCRIPTION OF SEVERAL VIEWS OF THE DRAWINGS

FIG. 1 illustrates a front view of a fluid filter assembly secured to a mounting stud of an engine according to an embodiment of the present invention.

FIG. 2 illustrates a cross-sectional view of an oil filter assembly secured to a mounting stud through line 2-2 of FIG. 1 according to an embodiment of the present invention.

FIG. 3 illustrates an isometric top view of a drain receptacle according to an embodiment of the present invention.

FIG. 4 illustrates an isometric front view of a drain receptacle according to an embodiment of the present invention.

FIG. 5 illustrates a top plan view of a drain receptacle according to an embodiment of the present invention.

FIG. 6 illustrates an isometric front view of a drain receptacle according to an embodiment of the present invention.

FIG. 7 illustrates an isometric view of a filter module positioned within a drain receptacle according to an embodiment of the present invention.

FIG. 8 illustrates a cross-sectional view of a filter module positioned within a drain receptacle through line 8-8 of FIG. 7 according to an embodiment of the present invention.

FIG. 9 illustrates a lateral cross-sectional view of a drain receptacle according to an embodiment of the present invention.

FIG. 10 illustrates a lateral cross-sectional view of a filter assembly during packaging according to an embodiment of the present invention.

FIG. 11 illustrates an isometric top view of a drain receptacle according to an embodiment of the present invention.

FIG. 12 illustrates an isometric top view of a drain receptacle according to an embodiment of the present invention.

FIG. 13 illustrates an isometric view of a drain receptacle according to an embodiment of the present invention.

FIG. 14 illustrates an isometric exploded view of a packaging system for a fluid filter assembly according to an embodiment of the present invention.

FIG. 15 illustrates an isometric front view of a filter module secured within a packaging system according to an embodiment of the present invention.

FIG. 16 illustrates an isometric exploded view of packaged fluid filter system according to an embodiment of the present invention.

FIG. 17 illustrates an isometric front view of a packaged filter system according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

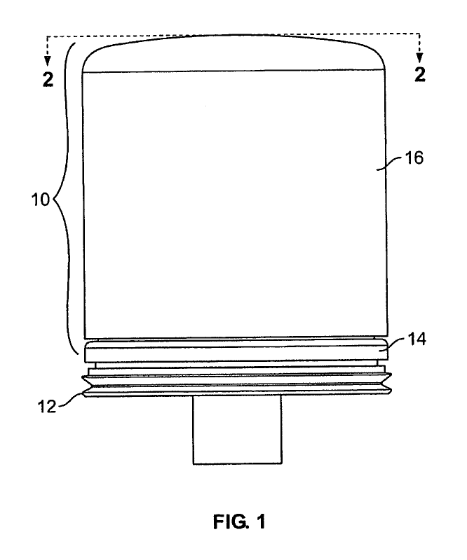

FIG. 1 illustrates a front view of a fluid filter assembly 10 secured to a mounting stud 12 of an engine according to an embodiment of the present invention. The fluid filter assembly 10 may include a first segment, such as a base or adapter 14 and a second segment, such as a filter refill, insert or module 16. The filter assembly 10 is configured to filter fluid, such as oil within an internal combustion engine. The filter assembly 10 may be a two piece assembly in which the adapter 14 is configured to threadably secure to the mounting stud 12, while the filter module 16 is configured to be threadably or otherwise removably secured to the adapter 14. For example, the fluid filter assembly 10 may be similar to the filter assemblies shown and described in U.S. application Ser. No. 11/033,566, filed Jan. 11, 2005, entitled “Oil Filter Assembly,” by Weinberger et al., which is hereby incorporated by reference in its entirety. Additionally, the fluid filter assembly 10 may be similar to the filter assemblies shown and described in U.S. application Ser. No. ______, filed Feb. 13, 2006, entitled “Oil Filter Assembly,” by Weinberger et al. (Attorney Docket No. 17207US01), which is hereby incorporated by reference in its entirety.

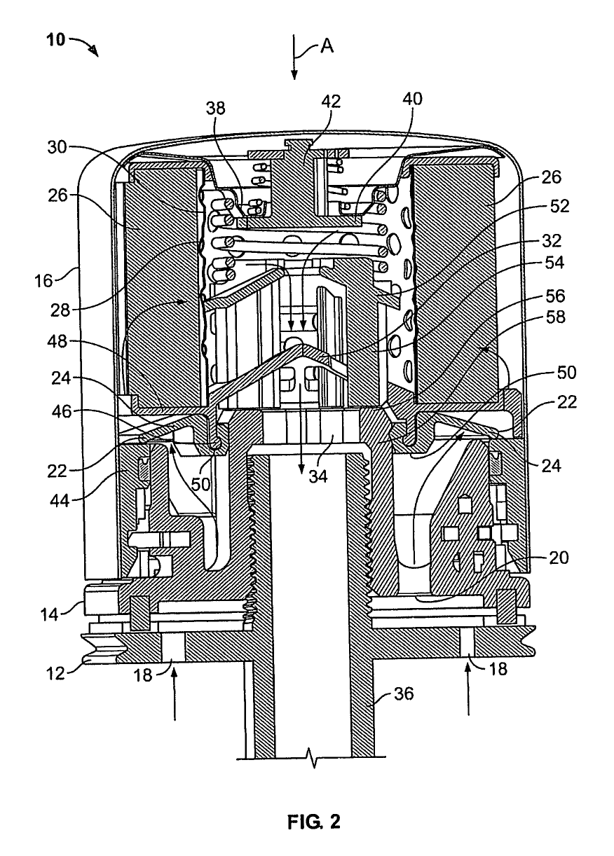

FIG. 2 illustrates a cross-sectional view of the oil filter assembly 10 secured to the mounting stud 12 through line 2-2 of FIG. 1. Unfiltered fluid from a source, such as oil from an engine, passes through outlets 18 of the mounting stud 12 into the adapter 14. The unfiltered oil then passes through fluid inlet passages 20 of the adapter 14. The pressure exerted by the unfiltered oil forces flap(s) 22 of an anti-drain valve 24 open and the unfiltered oil passes into a filter medium 26 of the filter module 16. The filter medium 26 filters impurities from the unfiltered oil. The filtered oil then passes through holes 28 of a central support tube 30 and through passages formed through a fluid outlet member 32. Optionally, instead of holes 28, a single central opening may be used. The filtered fluid then passes through a fluid outlet passage 34 of the adapter 14 and into a fluid inlet tube 36 of the mounting stud 12, which delivers the filtered fluid back to the source, such as an engine.

If, however, the filter medium 26 is clogged, unfiltered fluid will flow around the filter medium 26 into a pressure relief cap 38. As unfiltered fluid congregates within the pressure relief cap 38, the fluid exerts a pressure into a lower cap 40 of a pressure relief plug 42. The pressure exerted by the fluid may be sufficient to unseat the lower cap 40 from the pressure relief cap 38, as discussed in U.S. application Ser. No. ______ (Attorney Docket No. 17207US01).

The anti-drain valve 24 is positioned above a bottom plate 44 of the filter module 16 and is secured to a lower end 46 of a filter support 48. The anti-drain valve 24 includes the flap 22 and a fixed end 50 secured to the lower end 46 of the filter support 48. The flap 22 sealingly engages a top surface of the bottom plate 44. As fluid enters the module 16, the fluid exerts a pressure into the flap 22, thereby urging the flap 22 away from the bottom plate 44, and allowing fluid to pass therethrough. When the filter module 16 is removed from the adapter 14, however, the flap 22 sealingly abuts against a top surface of the bottom plate 44. As such, the anti-drain valve 24 prevents fluid within the filter module 16 from draining through openings sealed by the anti-drain valve 24.

Additionally, when the filter module 16 is removed from the adapter 14, a drip seal plug 52 of the module 16 is moved into sealing engagement with the fluid outlet member 32. That is, the drip seal plug 52 seals against the fluid outlet member 32, thereby sealing the openings formed through the fluid outlet member 32. Thus, the drip seal plug 52 acts to prevent fluid from passing through the fluid outlet member 32.

When the filter module 16 is mated with the adapter 14, legs 54 of the drip seal plug 52 abut against a top circumferential edge 56 of a fluid outlet tube 58 that defines the fluid outlet passage 34. As the legs 54 abut the top edge 56, and the module 16 is further urged in the direction of arrow A, the drip seal plug 52 remains stationary, while the fluid outlet member 32 continues to move downward. Thus, the drip seal plug 52 unseats from the fluid outlet member and moves out of sealing engagement with the fluid outlet member 32.

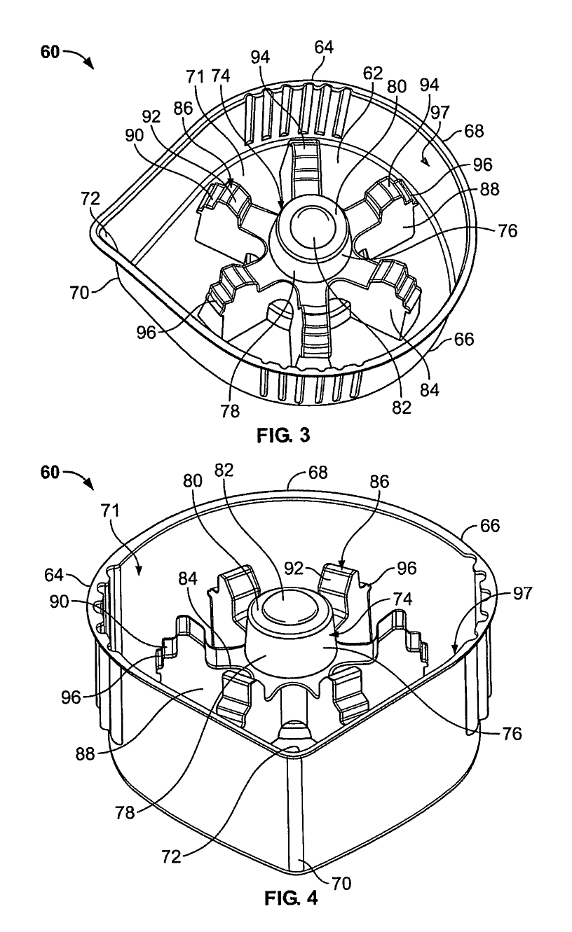

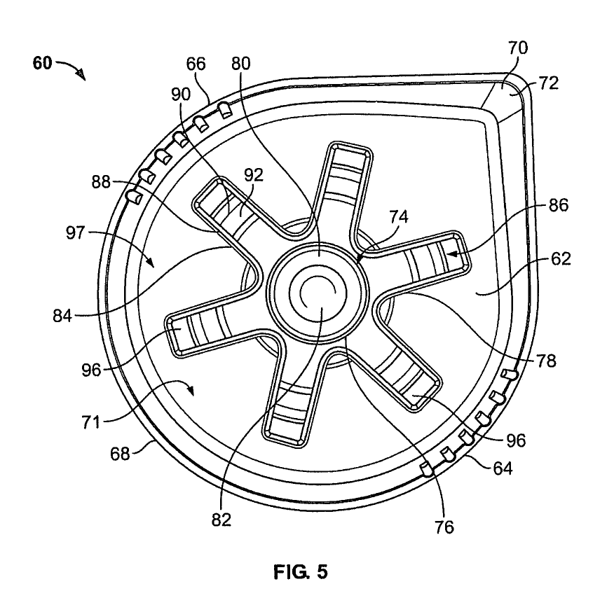

FIGS. 3, 4, and 5 illustrate an isometric top view, an isometric front view, and a top plan view, respectively, of a drain receptacle 60 according to an embodiment of the present invention. The drain receptacle 60 may be formed of plastic, metal, rubber, or various other materials. As shown, the drain receptacle 60 resembles a pan or other such object capable of retaining fluid. Referring to FIGS. 3-5, the drain receptacle 60 includes a base 62 integrally formed with lateral walls 64 and 66 that integrally connect at a rounded end 68 and a creased end 70. The upper portion of the creased end 70 defines a spout 72. The base 62, lateral walls 64 and 66, and the ends 68 and 70 define a retention cavity 71 therebetween.

A module-draining member 74 extends upwardly from a central portion of the base 62 within the retention cavity 71. The module-draining member 74 includes an upstanding central cylindrical post 76 having a cylindrical shaft 78 integrally formed with an upper ledge 80. A hemispherical protuberance 82 extends upwardly from the upper ledge 80.

Spokes 84 extend radially from the shaft 78 such that the central cylindrical post 76 forms a hub. Flap-engaging fingers 86 extend upwardly from distal ends 88 of the spokes 84. The fingers 86 may be barbs, posts, or other such protuberances that are configured to engage the flap(s) 22 (shown in FIG. 2) of the filter module 16 (shown in FIG. 2). Each finger 86 includes an upstanding main body 90 having a ramped surface 92 integrally connected to a top ledge 94. A ridge, tab, or other such protuberance 96 extends radially outward from the distal end 88 of each spoke 84. A module clearance area 97 is defined between distal ends 88 of the spokes 84 and interior surfaces of the lateral walls 64, 66, the rounded end 68, and the creased end 70.

The module-draining member 74 may be various shapes and sizes. For example, the post 76 may be rectangular, triangular, or other such shapes. Additionally, the module-draining member 74 may not include the spokes 84. Instead, the fingers 86 may extend upwardly from the base 62 without being connected to the post 76 through spokes. Additionally, while the drain receptacle 60 is shown having six spokes 84 and fingers 86, the drain receptacle 60 may include more or less spokes 84 and fingers 86 than those shown in FIGS. 3-5. FIG. 6, for example, shows a drain receptacle 98 having four spokes 100 and four connected flap-engaging fingers 102. Additionally, instead of upstanding fingers, the drain receptacles 60 or 98 may, instead, include an upstanding circumferential ridge having a flap-engaging ring extending upwardly therefrom.

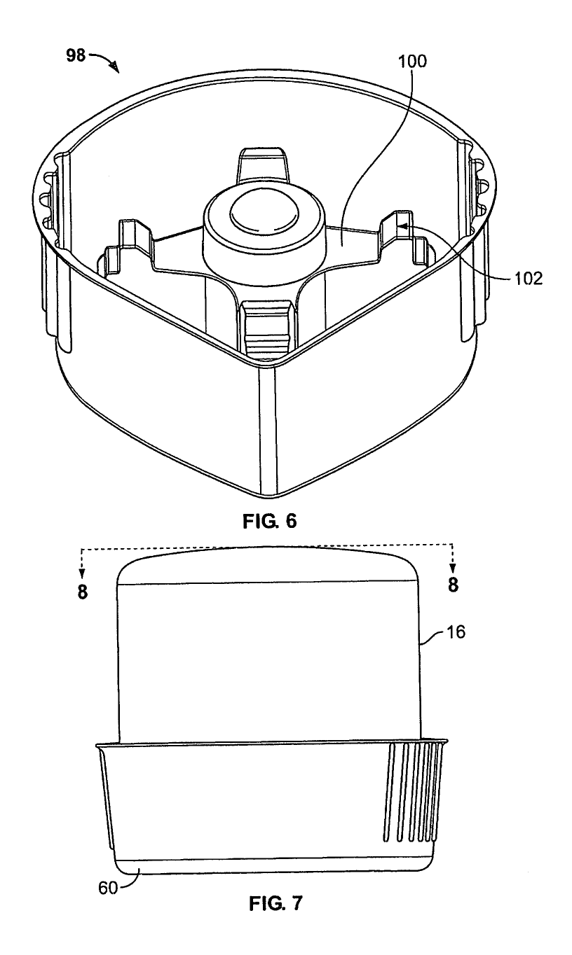

FIG. 7 illustrates an isometric view of the filter module 16 positioned within the drain receptacle 60. After the filter module 16 is removed from the adapter 14 (shown in FIGS. 1 and 2), the filter module 16 may be secured within the retention cavity 71 (shown, for example, in FIGS. 3-5) of the drain receptacle 60 in order to drain fluid from the filter module 16. When the filter module 16 is securely retained by the drain receptacle 60, the fingers 86 (shown, for example, in FIGS. 3-5) engage the flap(s) 22 (shown, for example, in FIG. 2) into an open position while the post 76 (shown, for example, in FIGS. 3-5) unseats the drip seal plug 52 (shown, for example, in FIG. 2) from the fluid outlet member 32 (shown, for example, in FIG. 2). As such, fluid within the filter module 16 drains into the drain receptacle 60.

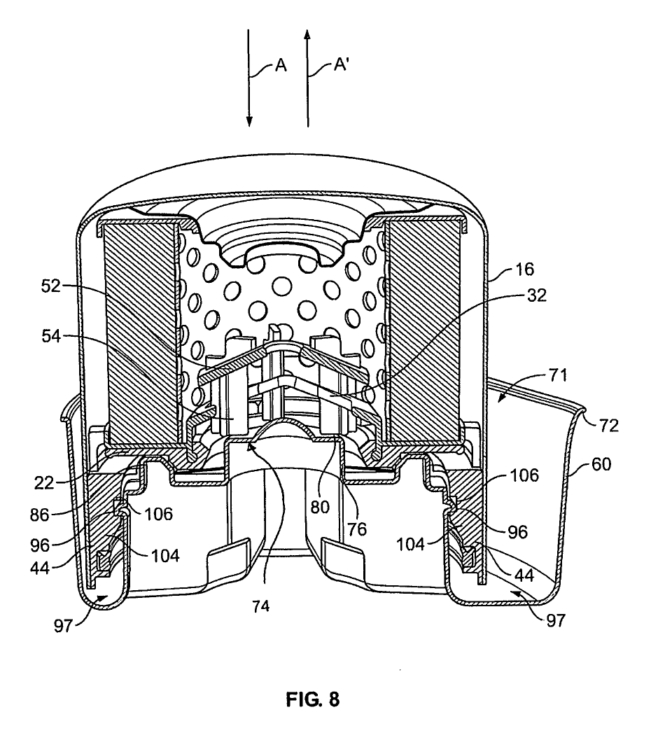

FIG. 8 illustrates a cross-sectional view of the filter module 16 positioned within the drain receptacle 60 through line 8-8 of FIG. 7. In order to drain fluid from the filter module 16, the filter module 16 is aligned over the module-draining member 74 such that the legs 54 of the drip seal plug 52 (which may be biased by a central spring) are positioned over the upper ledge 80 of the post 76 and the flap(s) 22 are positioned over the fingers 86. Then, the filter module 16 is urged into the retention cavity 71 in the direction of arrow A.

The bottom plate 44 of the filter module 16 moves in the module clearance area 97 of the drain receptacle 60 such that ramped ends 104 of the bottom plate 44 slide over the radially-extending tabs 96 until the tabs 96 snapably engage notches 106 formed in the bottom plate 44. Once the tabs 96 snap into the notches 106, the drain receptacle 60 securely retains the filter module 16. Optionally, the bottom plate 44 may include an inwardly-extending tab, or annular ridge, while the drain receptacle 60 includes notches formed through distal ends 88 of the spokes 84.

At the same time that the bottom plate 44 of the filter module 16 is securing to the tabs 96, the flap(s) 22 is urged into the flap-engaging fingers 86 such that the flap-engaging fingers 86 unseat the flap(s) 22 from the bottom plate 44 opening a fluid passage therebetween. Fluid within the filter module 16 may then drain through this fluid passage into the retention cavity 71 where it is retained.

Additionally, during this time, the legs 54 of the drip seal plug 52 abut against the upper ledge 80 of the post 76. As the filter module 16 continues to be urged in the direction of arrow A, the drip seal plug 52 separates from the fluid outlet member 32, thereby allowing fluid to flow through the opening of the fluid outlet member 32 into the retention cavity 71 of the drain receptacle 60.

When the filter module 16 is securely retained by the drain receptacle 60, fluid within the filter module 16 drains through the passages described above, and is collected within the retention cavity 71 of the drain receptacle 60. After the fluid completely drains out of the filter module 16, the fluid collected within the retention cavity 71 may be poured out into another receptacle through the spout 72. The filter module 16 may be removed from the drain receptacle 60 by securing the drain receptacle 60 in place and then removing the filter module 16 in the direction of arrow A′. Optionally, the filter module 16 may include buttons, clasps, latches, or the like that may be engaged to cause the bottom plate 44 to disengage from the drain receptacle 60. However, the unit defined by the filter module 16 and the drain receptacle 60 may, instead, be discarded after the fluid is drained from the filter module 16 and poured from the drain receptacle 60.

FIG. 9 illustrates a lateral cross-sectional view of a drain receptacle 110 according to an embodiment of the present invention. The drain receptacle 110 is a two-piece design including a container 112 and a filter-engaging member 114. The container 112 is separate and distinct from the filter-engaging member 114. That is, the container 112 and the filter-engaging member 114 are not integrally formed with one another as a single piece. The container 112 includes a central stud 116 over which the filter-engaging member 114 may be positioned and/or secured. The filter-engaging member 114 includes an upwardly-extending post 118 integrally formed with lateral flap-engaging clips 120. Module-engaging tabs 122 extend radially from the flap-engaging clips 120. In operation, the drain receptacle 110 engages the filter module 16 (shown, for example, in FIGS. 1 and 2) similar to the way the drain receptacle 60 (shown, for example, in FIGS. 3-5, and 7-8) engages the filter module 16.

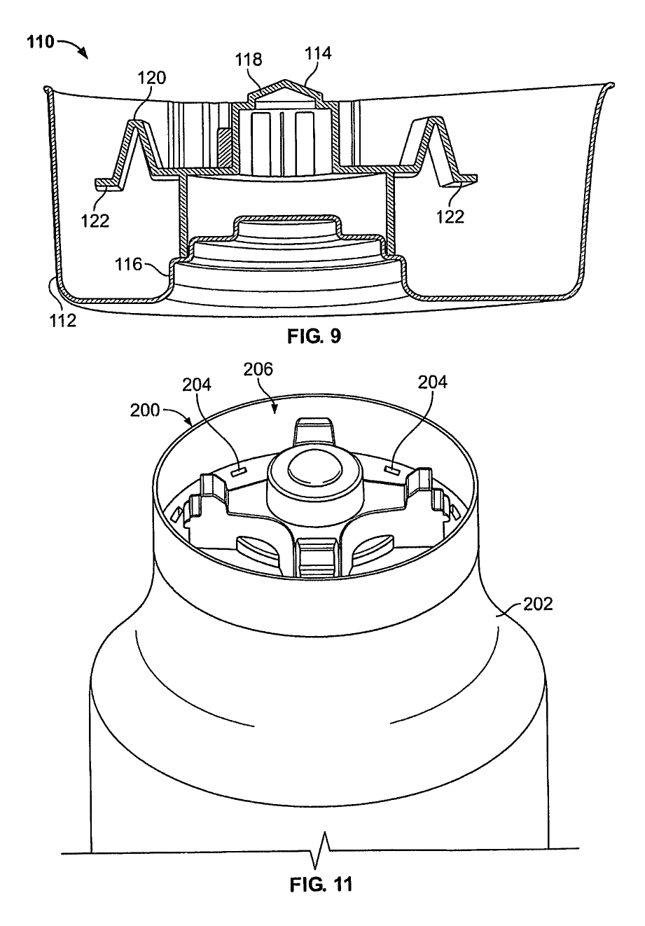

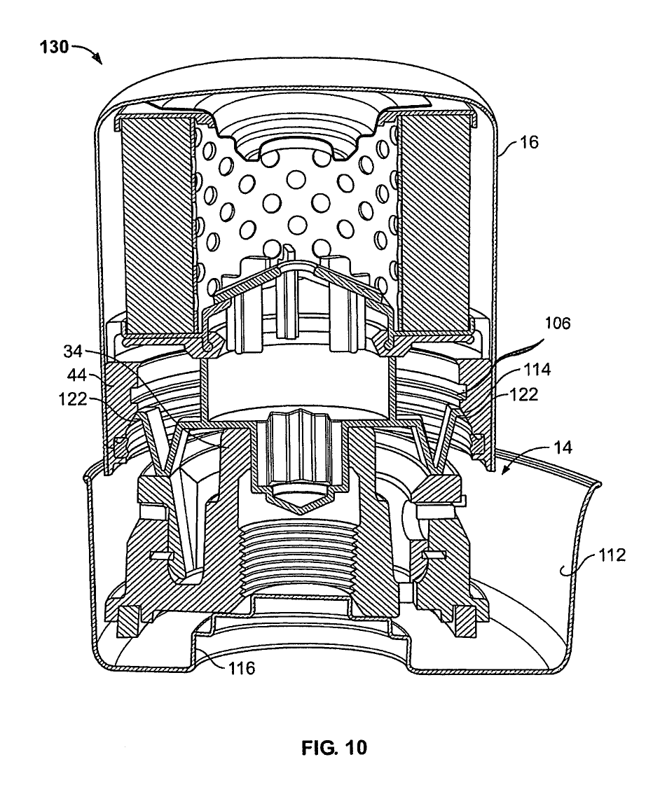

FIG. 10 illustrates a lateral cross-sectional view of a filter assembly 130 during packaging according to an embodiment of the present invention. When the filter assembly 130 is packaged for shipping to a customer, the filter module 16 is separated from the adapter 14 by the filter-engaging member 114, while the container 112 is separated from the filter-engaging member 114 by the adapter 14. The filter-engaging member 114 is oriented upside down so that the central stud 116 is positioned within the fluid outlet passage 34 of the adapter 14. While the module-engaging tabs 122 of the filter-engaging member 114 may be positioned within, or snap into, the notches 106 of the bottom plate 44, the flap-engaging clips 120 may be squeezed together to remove the tabs 122 from the notches 106. In this way, every time a consumer purchases an filter assembly 130, the consumer is provided a drain receptacle, adapter and filter module.

FIG. 11 illustrates an isometric top view of a drain receptacle 200 according to an embodiment of the present invention. The drain receptacle 200 is similar to the drain receptacles discussed above, except that it is integrally formed with a bottle 202. Drain passages 204 allow collected fluid to pass from the retention cavity 206 into the bottle 202. The drain receptacle 200, including the bottle 202 filled with fluid, may then be sent to a fluid disposal or recycling center.

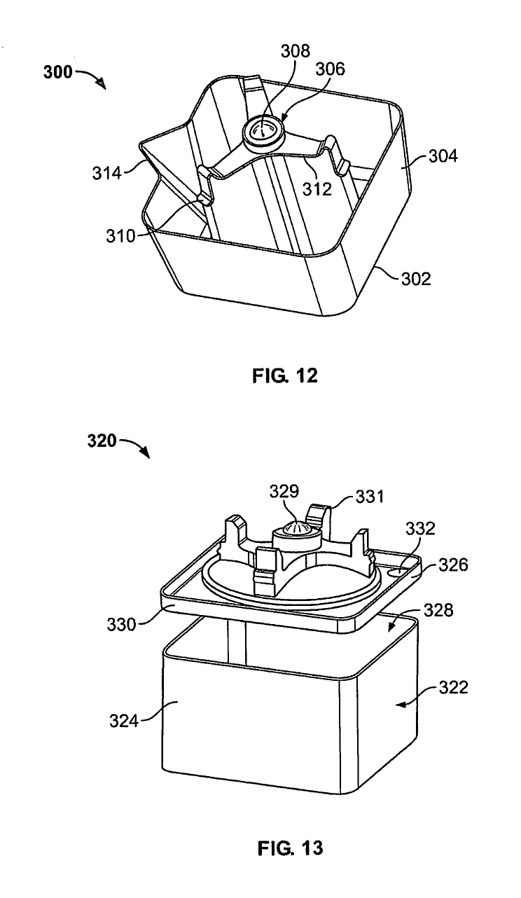

FIG. 12 illustrates an isometric top view of a drain receptacle 300 according to an embodiment of the present invention. The drain receptacle 300 includes a base 302 integrally formed with four upstanding walls 304. A draining member 306 extends upwardly from the base 302. The draining member 306 includes an upstanding post 308 connected to three fingers 310 through spokes 312. A spout 314 is formed in one of the upstanding walls 304. While the drain receptacle 300 is shown as a rectangular drain receptacle, the drain receptacle 300 may be various other shapes and sizes. Further, the draining member 306 may include more or less fingers 310 than those shown in FIG. 12.

FIG. 13 illustrates an isometric view of a drain receptacle 320 according to an embodiment of the present invention. The drain receptacle 320 includes a pan 322 having a base (not shown) integrally formed with upstanding walls 324. A separate and distinct draining member 326 is configured to be positioned within a drain cavity 328 of the pan 322, or positioned over the pan 322. The draining member 326 includes an upstanding post 329 and fingers 331 upwardly extending from a base plate 330. Additionally, a drain passage 332 may be formed through the base plate 330. The drain passage 332 is configured to allow fluid to pass through the base plate 330 into the pan 322.

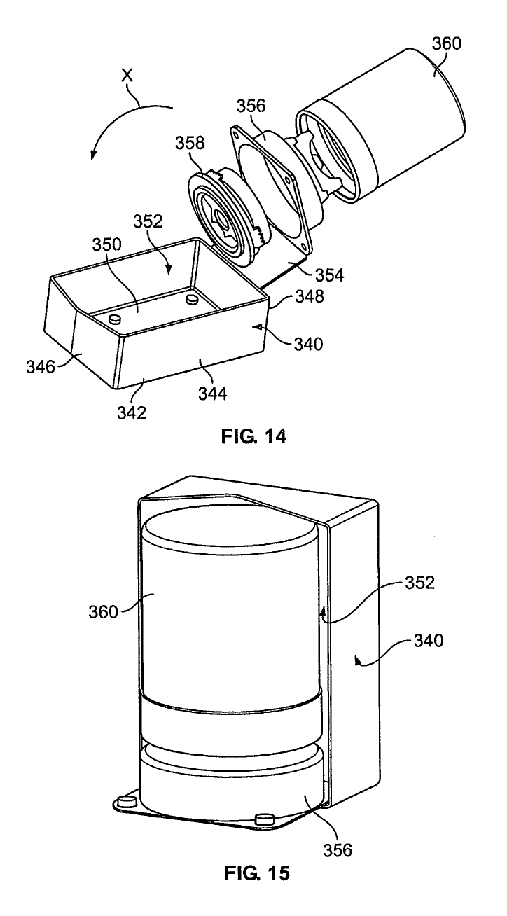

FIG. 14 illustrates an isometric exploded view of a packaging system 340 for a fluid filter assembly according to an embodiment of the present invention. The packaging system 340 includes a housing 342 defined by laterals walls 344 integrally formed with top, bottom, and back walls 346, 348, and 350, respectively, defining a filter cavity 352 therebetween. A flap 354 extends from the bottom wall 348 and is separably connected (such as through snaps, perforations, or the like) to a drain receptacle 356. During packaging, a filter adapter 358 may be positioned underneath the drain receptacle 356, which may then be pivoted into the filter cavity 352 in the direction of arc X. A filter module or housing 360 may be positioned over the drain receptacle 356.

FIG. 15 illustrates an isometric front view of the filter module 360 secured within the packaging system 340. The adapter 358 (shown in FIG. 14) is positioned underneath the drain receptacle 356, which has been swung into the filter cavity 352.

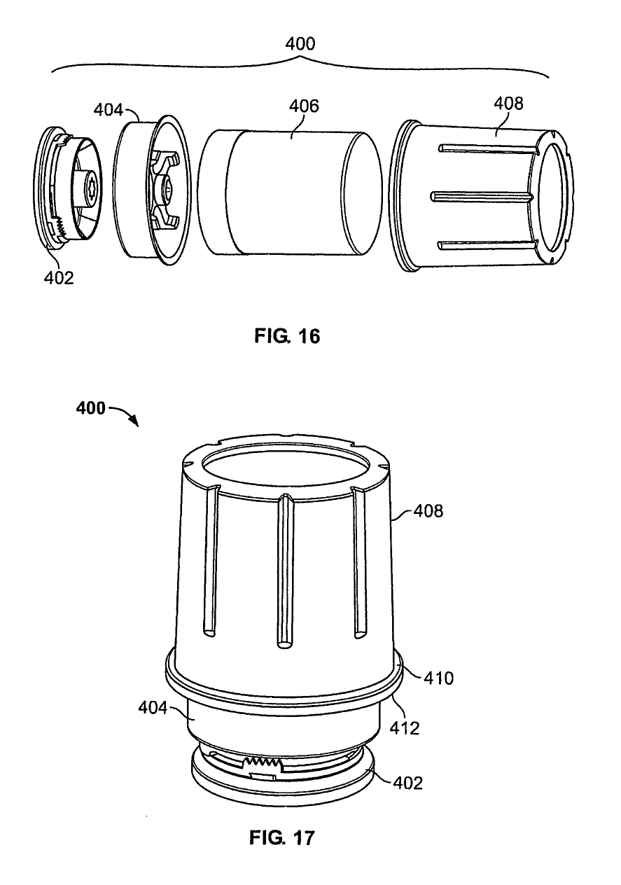

FIG. 16 illustrates an isometric exploded view of a packaged fluid filter system 400 according to an embodiment of the present invention. The system 400 includes an adapter 402 that is secured underneath a drain receptacle 404, which in turn supports a filter module 406. A cover 408 is positioned over the filter module 406 and is removably secured to the drain receptacle 404, securing the filter module 406 therebetween.

FIG. 17 illustrates an isometric front view of the packaged filter system 400. A lip 410 of the cover 408 may snapably secure into a reciprocal circumferential member 412 of the drain receptacle 404.

While the embodiments of the drain receptacle are shown having particular shapes and sizes, it is to be understood that the drain receptacles may be various shapes and sizes. Additionally, the drain receptacle may be used with a filter module of a one-, two-, or three-piece oil filter assembly.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A drain receptacle configured to drain fluid from a filtering device having first and second fluid passages, the drain receptacle comprising:
a base and upstanding walls, a retention cavity being defined between said base and said upstanding walls; and
a draining member extending from said base within said retention cavity, said draining member configured to open at least one of the first and second fluid passages when the filtering device is secured to the drain receptacle in order to drain fluid within the filtering device into said retention cavity.

2. The drain receptacle of claim 1, wherein said upstanding walls form a spout configured to allow fluid collected within said retention cavity to be poured out of said retention cavity.

3. The drain receptacle of claim 1, wherein said draining member comprises a post extending from said base within said retention cavity, said post configured to open the first fluid passage when the filtering device is secured to the drain receptacle.

4. The drain receptacle of claim 1, wherein said draining member comprises at least one finger extending from said base within said retention cavity, said at least one finger being positioned a radial distance from a center of said base, said at least one finger configured to open the second fluid passage when the filtering device is secured to the drain receptacle.

5. The drain receptacle of claim 1, wherein said draining member comprises a plurality of regularly-spaced fingers extending from said base within said retention cavity about a center of said base, said plurality of regularly-spaced fingers configured to open the second fluid passage when the filtering device is secured to the drain receptacle.

6. The drain receptacle of claim 1, further comprising a detent extending from at least one of said upstanding walls and said draining member within said retention cavity, a notch of the filtering device configured to securely retain said detent to secure the filtering device to the drain receptacle.

7. The drain receptacle of claim 1, wherein at least one of said upstanding walls and said draining member comprises a notch, said notch configured to securely retain a detent of the filtering device.

8. The drain receptacle of claim 6, wherein said detent comprises a tab radially extending from said draining member.

9. The drain receptacle of claim 1, wherein said base is integrally connected to a bottle, said base further comprising at least one drain passage formed therethrough, wherein said drain passage is configured to allow fluid within said retention cavity to drain into said bottle through said at least one drain passage.

10. The drain receptacle of claim 1, wherein said draining member is separate and distinct from said base.

11. The drain receptacle of claim 1, wherein said base is integrally connected to said upstanding walls.

12. A method of draining fluid within a filtering device having fluid passages that are sealed, the method comprising:
securing the filtering device to a drain receptacle;
unsealing the fluid passages due to said securing step; and
draining fluid within the filtering device through the unsealed fluid passages.

13. The method of claim 12, further comprising collecting fluid from said draining step within a retention cavity of the drain receptacle.

14. The method of claim 13, further comprising pouring the fluid within the retention cavity into a disposal tank.

15. The method of claim 13, further comprising passing the fluid within the retention cavity into an integrally connected bottle.

16. The method of claim 13, wherein said securing step comprises snapably securing a detent of the drain receptacle into a notch of the filtering device.

17. A drain receptacle configured to drain fluid from a filter module including a bottom plate having a circumferential notch formed therethrough, a fluid inlet sealed by a first sealing member, and a fluid outlet sealed by a second sealing member, the drain receptacle comprising:
a base integrally formed with upstanding walls joining to form a rounded end and a creased end defining a spout, a retention cavity being defined between said base and said upstanding walls, said spout configured to allow fluid collected within said retention cavity to be poured out of said retention cavity;
a module-draining device extending from said base within said retention cavity, said module-draining device configured to unseal the fluid inlet and the fluid outlet when the filter module is secured to the drain receptacle in order to drain fluid within the filter module into said retention cavity, said module-draining device comprising: (i) a post extending from a center of said base within said retention cavity, said post configured to open the fluid outlet when the filtering device is secured to the drain receptacle; and (ii) at least one finger extending from said base within said retention cavity, said at least one finger positioned a radial distance from the center of said base, said at least one finger configured to open the fluid inlet when the filtering device is secured to the drain receptacle; and
a detent extending from at least one of said upstanding walls and said module-draining member within said retention cavity, the notch of the filter module being configured to securely retain said detent to secure the filter module to the drain receptacle.

18. The drain receptacle of claim 17, wherein said at least one finger comprises a plurality of regularly-spaced fingers extending from said base within said retention cavity about the center of said base.

19. The drain receptacle of claim 17, wherein said detent comprises a tab radially extending from said module-draining device.

20. The drain receptacle of claim 17, wherein said base is integrally connected to a bottle, said base further comprising at least one drain passage formed therethrough, wherein said drain passage is configured to allow fluid within said retention cavity to drain into said bottle through said at least one drain passage.

21. The drain receptacle of claim 17, wherein said module-draining device further comprises at least one spoke, wherein said at least one finger is integrally connected to said post through a said at least one spoke.

22. The drain receptacle of claim 17, wherein said module-draining device is separate and distinct from said base.
